(19) United States
(12) Patent Application Publication
(10) Pub. No.: US 2017/0326916 A1
(43) Pub. Date: Nov. 16, 2017

(54) Carcass Reinforcement For Motor Bike Tire

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Benjamin VILPERT, Clermont-Ferrand Cedex 9 (FR); Alexandra CURAT, Clermont-Ferrand Cedex 9 (FR); Christophe LAURENT, Clermont-Ferrand Cedex 9 (FR); Romain BOUCHET, Clermont-Ferrand Cedex 9 (FR)

(73) Assignees: COMPAGNIE GENERALE DES ETABLISSEMENTS MICHELIN, Clermont-Ferrand (FR); MICHELIN RECHERCE ET TECHNIQUE S.A., Granges-Paccot (CH)

(21) Appl. No.: 15/526,828

(22) PCT Filed: Sep. 29, 2015
(86) PCT No.: PCT/EP2015/072337

§ 371 Date: May 15, 2017

(30) Foreign Application Priority Data
Nov. 18, 2014 (FR) 1461105

(51) Int. Cl. B60C 9/06

(52) U.S. Cl. CPC B60C 9/06; B60C 2200/10

(57) ABSTRACT

Tire (1) for a motorized two-wheeled vehicle of the motorbike type. A good compromise between the stability of the motorbike in a straight line at high speed and the stability of the motorbike in a curved path with a high camber angle is achieved with reinforcers of a first carcass layer (61) that form, with the circumferential direction (XX′), an angle (A₁) at most equal to 75°, the reinforcers of a second carcass layer (62) form, with the circumferential direction, an angle (A₂) at least equal to 80° and at most equal to 90°, the difference between the angles (A1, A2) of the respective reinforcers of the first and second carcass layers (61, 62) is at least equal to 10° and at most equal to 20° and the angles (A1, A2) of the respective reinforcers of the first and second carcass layers (61, 62) are oriented in the same direction.

The invention relates to a radial tire intended to be fitted to a motorized two-wheeled vehicle such as a motorcycle or motorbike.

Although not restricted to such an application, the invention will be described more particularly with reference to a radial tire intended to be mounted on the rear of a motorbike, and more particularly still, on the rear of a motorbike in the sporting sector.

In what follows and by convention, the circumferential, axial and radial directions respectively denote a direction tangential to the tread surface of the tire in the direction of rotation of the tire, a direction parallel to the axis of rotation of the tire, and a direction perpendicular to the axis of rotation of the tire. What is meant by “radially inside and, respectively, radially outside” is “closer and, respectively, further away from the axis of rotation of the tire”. What is meant by “axially inside and, respectively, axially outside” is “closer to and, respectively, further away from, the equatorial plane of the tire”, the equatorial plane of the tire being the plane passing through the middle of the tread surface of the tire and perpendicular to the axis of rotation of the tire. Angles with respect to the circumferential direction that are mentioned in what follows are not oriented and are given in terms of absolute value.

In general, a tire comprises a tread intended to come into contact with the ground via the tread surface, and connected by two sidewalls to two beads providing a mechanical connection between the tire and the rim on which it is mounted.

A radial tire also comprises a reinforcement comprising a crown reinforcement, radially on the inside of the tread, and a carcass reinforcement, usually radially on the inside of the crown reinforcement.

The crown reinforcement of a radial motorbike tire generally comprises at least one crown layer made up of reinforcers coated in a polymer material of elastomer type. The reinforcers are usually made of a textile material, such as aramid, but may equally be made of metal. Those skilled in the art have proposed various crown reinforcement architectures according to whether the tire is intended to be mounted on the rear or mounted on the front of the motorbike, in the case of a sports motorbike. In the case of a rear mounting, the crown reinforcement is usually made up of a circumferential crown layer comprising circumferential reinforcers, which means to say reinforcers which, with the circumferential direction, form a substantially zero angle at most equal to 5°. This circumferential crown layer is generally obtained by helical winding of a strip of at least one elastomer coated reinforcing element. In the case of a front mounting, the crown reinforcement also comprises a circumferential crown layer or, sometimes, two working crown layers, comprising reinforcers that are substantially parallel to one another within each layer and crossed from one layer to the next, forming with the circumferential direction angles generally comprised between 15° and 35°.

The carcass reinforcement of a radial motorbike tire generally comprises at least one carcass layer made up of reinforcers usually made of textile material coated in a polymer material of elastomer type. A carcass layer may or may not have a turnup.

A carcass layer is said to have a turnup when it comprises a main part, connecting the two beads to one another, and is wrapped within each bead from the inside towards the outside of the tire around a bead wire to form a turnup that has a free end. The bead wire is a circumferential reinforcing element, usually made of metal and coated in a generally elastomeric or textile material. In the case of a carcass layer with a turnup, the turnup in each bead anchors the turned-up carcass layer to the bead wire. The portion of bead wire in contact with the turned-up carcass layer contributes, particularly upon inflation, to the reaction by coupling of the tensile loadings in the turned-up carcass layer. This contribution to reacting the tension loadings is dependent on the torsional rigidity of the bead wire and on the geometry of the turnup. In instances in which the bead wire has high torsional stiffness, the tension loadings on inflation are essentially reacted by the bead wire, with the turnup making a secondary contribution. In instances in which the bead wire has a lower torsional stiffness, the tension loadings are reacted both by coupling with the bead wire and by shear between the turnup and the materials adjacent to it, thereby requiring a turnup that is sufficiently long, which means to say the end of which is sufficiently radially distant from the radially innermost point of the bead wire. A turnup is said to be long when the radial distance between its end and the radially innermost point of the bead wire is at least equal to 0.3 times the design section height of the tire as defined by the standards of the European Tire and Rim Technical Organisation or ETRTO.

A carcass layer does not have a turnup when it is made up only of a main part, connecting the two beads together, without being wrapped around a bead wire. In the case of a carcass layer without a turnup, each of the two end portions of the said non-turned-up carcass layer may be coupled either with the turnup of at least one turned-up carcass layer or with the main part of at least one turned-up carcass layer. What is meant by coupling is a region of overlap between the carcass layer without a turnup and a turned-up carcass layer, allowing tensile loadings to be reacted by shear.

The reinforcers in the main part of a carcass layer with or without a turnup are substantially mutually parallel and form, with the circumferential direction, an angle comprised between 65° and 90°.

A known architecture of radial tire for mounting at the rear of a motorbike, described in document WO-2011107543 comprises a carcass reinforcement made up of two carcass layers which is radially on the inside of a crown reinforcement made up of a circumferential crown layer. The respective reinforcers of each of the two carcass layers form, with the circumferential direction, angles of opposite sign and comprised between 70° and 85°. Such an architecture, because of the triangulation effect resulting from the criss-crossing of the reinforcers from one carcass layer to the other, particularly in the sidewalls, guarantees the motorbike sufficient stability in a curved path in which the camber angle of the rear tire, between the equatorial plane of the tire and the plane perpendicular to the ground and tangential to the path, is usually at least equal to 30°. However, such an architecture has the disadvantage of not making it possible to achieve an optimum compromise between stability in a curved path and stability in a straight line. This performance compromise is actually important particularly in the field of motorbikes for sporting use the use of which is characterized by a need for grip on dry ground and use on a circuit where at least 50% of the path is in a curved line.

The inventors have set themselves the objective of designing a carcass reinforcement for a radial tire to be fitted at the rear of a motorbike that makes it possible to guarantee a good compromise between the stability of the motorbike in a straight line at high speed and the stability of the motorbike in a curved path with a high camber angle.

This objective has been achieved, according to the invention, by a tire for a motorized two-wheel vehicle of the motorbike type, comprising:
a tread connected by two sidewalls to two beads, each bead comprising a metal circumferential reinforcing element or bead wire,
a crown reinforcement extending radially inside the tread and comprising at least one crown layer, the at least one crown layer comprising mutually parallel reinforcers forming, with a circumferential direction of the tire, an angle at most equal to 5°,
a carcass reinforcement extending radially on the inside of the crown reinforcement as far as into the beads and comprising at least two carcass layers, each of the at least two carcass layers comprising mutually parallel reinforcers forming, with the circumferential direction of the tire, an angle at least equal to 65°,
the reinforcers of a first carcass layer forming, with the circumferential direction, an angle at most equal to 75°,
the reinforcers of a second carcass layer forming, with the circumferential direction, an angle at least equal to 80° and at most equal to 90°,
the difference between the angles of the respective reinforcers of the first and second carcass layers is at least equal to 10° and at most equal to 20°
and the angles (A1, A2) of the respective reinforcers of the first and second carcass layers are oriented in the same direction.

The crown reinforcement, extending radially on the inside of the tread, comprises at least one crown layer, comprising mutually parallel reinforcers forming, with a circumferential direction of the tire, an angle at most equal to 5°. That means that the reinforcers of the said crown layer are substantially parallel to the circumferential direction of the tire, namely are substantially circumferential. This range of angles relates to the angle measured at any point of the crown layer comprised between the two axial ends of the said crown layer. Moreover, this angle may vary according to the point on the crown layer concerned.

The carcass reinforcement, extending radially on the inside of the crown reinforcement as far as into the beads, comprises at least two carcass layers of which the respective mutually parallel reinforcers form, with the circumferential direction of the tire, an angle at least equal to 65°. This range of angles relates to the angle measured at any point on each carcass layer, comprised between the two ends of the said carcass layer. Moreover, this angle may vary according to the point on the carcass layer concerned.

According to the invention, the reinforcers of a first carcass layer form, with the circumferential direction, an angle at most equal to 75°, whereas the reinforcers of a second carcass layer form, with the circumferential direction, an angle at least equal to 80° and at most equal to 90°. In other words, the reinforcers of the first carcass layer form, with the circumferential direction, a smaller angle than those of the second carcass layer which are substantially radial, thereby involving triangulation of the carcass reinforcement. In addition, the difference between the angles of the respective reinforcers of the first and second carcass layers is at least equal to 10° and at most equal to 20°, meaning that the triangulation needs to be significant in order to be effective. Finally, the angles (A1, A2) of the respective reinforcers of the first and second carcass layers are oriented in the same direction, namely are of the same sign in an oriented plane defined by the circumferential and axial directions of the tire.

Such triangulation of the carcass reinforcement, both in the crown portion and in the sidewall portions, makes it possible simultaneously to have high lateral stiffness and high cornering stiffness.

The lateral stiffness is the lateral force generated by the tire, when a lateral displacement, namely a displacement parallel to the axial direction, equal to 1 mm, is applied to it. The higher the lateral stiffness, which is dependent chiefly upon the triangulation of the carcass reinforcement in the sidewall portions, the higher the stability of the motorbike in a straight line.

The cornering stiffness is the lateral force generated by the tire or drift thrust, when a cornering angle of 1° is applied to it, the cornering angle being the angle formed by the straight line which is the intersection of the equatorial plane of the tire with the ground, and the straight line tangential to the path. The higher the cornering stiffness, which is essentially dependent on the triangulation of the carcass reinforcement in the crown portion, the higher the stability of the motorbike in a curve.

According to one preferred embodiment, the carcass reinforcement is made up of two carcass layers, thereby constituting a carcass bi-ply. This is the number of carcass layers usually employed in order to minimize the mass of the tire and its cost of production.

Advantageously, the first carcass layer is a carcass layer turned up around the bead wire of each bead. In other words, the first carcass layer of which the reinforcers form, with the circumferential direction, the smallest angle at most equal to 75°, is a turned-up carcass layer comprising a main portion connecting the two beads together and wrapped, within each bead, from the inside towards the outside of the tire around a bead wire to form a turnup that has a free end. The method of laying a turned-up carcass ply when layering the constituent elements of the tire is a method that is commonplace in the field of tire manufacture.

Also advantageously, the first carcass layer is radially on the inside of the second carcass layer. The carcass layer of which the reinforcers form, with the circumferential direction, the smallest angle at least equal to 65° and at most equal to 75°, is thus radially on the inside of the carcass layer of which the reinforcers form, with the circumferential direction, the largest angle at least equal to 80° and at most equal to 90°. For preference, the first carcass layer is also a turned-up carcass layer.

The second carcass layer is a carcass layer without a turnup around the bead wire of each bead. In the particular case in which the carcass layer consists only of two carcass layers and in which the first carcass layer is turned up and radially on the inside of the second carcass layer, an end portion of the second carcass layer is either in contact with the main part of the turned-up first carcass layer or with the turnup of the turned-up first carcass layer. In the case of an overlap with the turnup of the turned-up first carcass layer, the end portion of the second carcass layer is either axially on the outside of the turnup or, for preference, axially on the inside of the said turnup.

The respective reinforcers of the first and second carcass layers are usually made of textile material. The textile materials commonly used are polyester or nylon. These materials are commonly used in the field of motorbike tires because of the attractive compromise between their performance and their cost of manufacture. Aramid, which is a textile material with even better performance in terms of elastic modulus and breaking strength, may be used in high performance tires, such as tires for competition motorbikes.

For preference, the respective reinforcers of the first and second carcass layers are made of the same textile material, so as to standardize the material of which the reinforcers of the carcass layers are made and therefore minimize production costs.

According to a preferred alternative form of textile material, the respective reinforcers of the first and second carcass layers are made of polyester, which offers a good performance/cost compromise.

Advantageously, the crown reinforcement is made up of a single crown layer. As a result, this single crown layer comprises reinforcers that are mutually parallel and form, with a circumferential direction of the tire, an angle at most equal to 5°. A crown layer with circumferential reinforcers is commonly used in a tire intended to be fitted to the rear of a motorbike, in order to increase the circumferential stiffness of the tire and thus allow it to achieve high speeds without experiencing excessive deformation.

For preference, the reinforcers of the at least one crown layer are made of textile material, preferably aromatic polyamide. Specifically, the high elastic modulus of a reinforcer made of aromatic polyamide, such as aramid, contributes to increasing the circumferential stiffness of the tire, which stiffness is already high given the substantially circumferential direction of the reinforcers of the crown layer.

With each of the at least two carcass layers having a crown portion extending symmetrically on each side of an equatorial plane passing through the middle of the tread and perpendicular to an axis of rotation of the tire, it is finally advantageous for the mean radial distance respectively between the respective reinforcers of two consecutive carcass layers, in their crown portions, on the one hand, and between the respective reinforcers of the radially outermost carcass layer, in its crown portion, and of the radially innermost crown layer, on the other hand, to be at most equal to 0.3 mm, preferably at most equal to 0.1 mm What is meant by the mean radial distance respectively between the respective reinforcers of two consecutive layers is the distance measured, in the radial direction, between two reinforcers respectively belonging to the crown portions of two layers in contact with one another. This maximum distance, which characterizes the mechanical coupling between the layers, governs the stiffnesses of the tire.

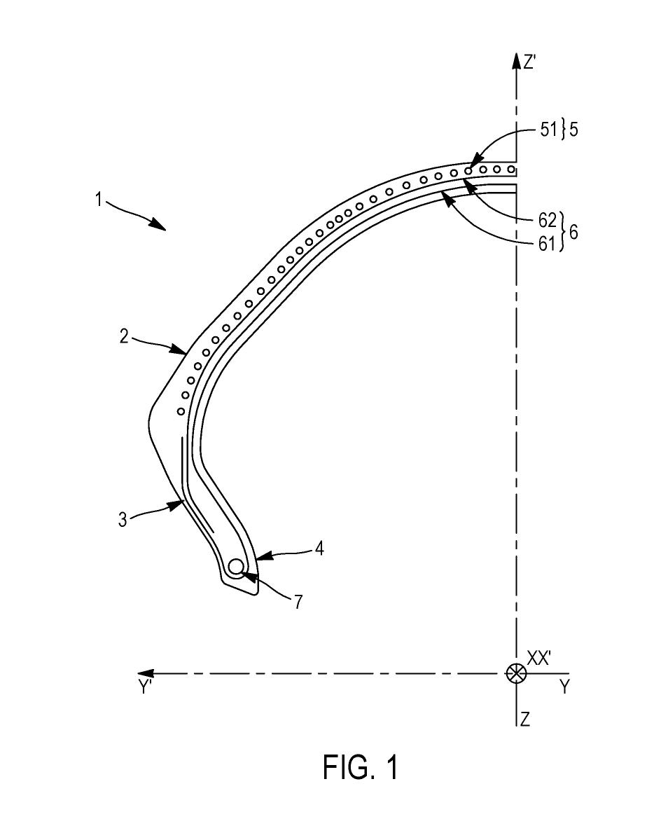

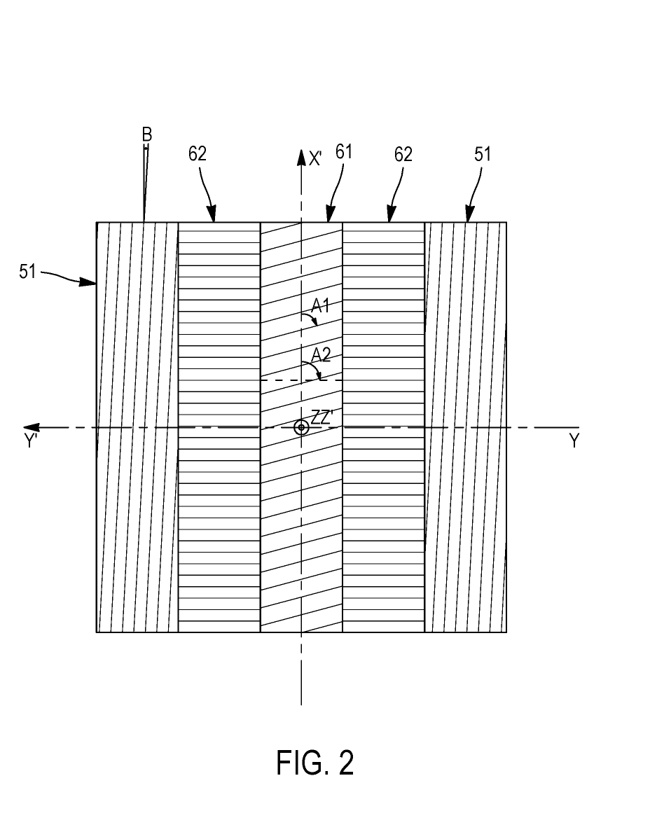

Further details and advantageous features of the invention will become apparent hereinafter from the description of the invention given with reference to FIGS. 1 and 2 which depict:

FIG. 1: a meridian half section of a reference tire of the prior art,

FIG. 2: a view from above of the crown of a tire according to a preferred embodiment of the invention.

In order to make them easier to understand, FIGS. 1 and 2 have not been drawn to scale.

FIG. 1 depicts, in a meridian plane YZ defined by the respectively axial YY′ and radial ZZ′ directions, a meridian half section of a tire 1 for a motorized two-wheeled vehicle of the motorbike type, comprising a tread 2 connected by two sidewalls 3 to two beads 4, each bead 4 comprising a metal circumferential reinforcing element or bead wire 7. The tire 1 comprises a crown reinforcement 5 extending radially on the inside of the tread 2 and comprising a single crown layer 51, the crown layer 51 comprising mutually parallel reinforcers forming, with a circumferential direction XX′ of the tire, an angle B at most equal to 5°. Furthermore, the tire 1 comprises a carcass reinforcement 6 extending radially on the inside of the crown reinforcement 5 as far as into the beads 4 and made up of two carcass layers (61, 62), each of the two carcass layers (61, 62) comprising mutually parallel reinforcers forming, with the circumferential direction XX′ of the tire, an angle (A1, A2) at least equal to 65°. The radially inner layer 61 is a carcass layer turned up around the bead wire 7, whereas the radially outer layer of 62 is a carcass layer that is not turned up or wrapped round. A free end portion of the carcass that is not turned up 62 is axially on the inside of and in contact with the turnup of the turned-up carcass layer 61.

FIG. 2 depicts a view from above of a crown portion of a tire according to the invention. More specifically, this is a view in cross section illustrating the respective angles of the layers radially superposed from the inside to the outside: a radially inside first carcass layer 61, a radially outside second carcass layer 62 and the crown layer 51. According to the invention, the reinforcers of the first carcass layer 61 form, with the circumferential direction XX′, an angle A₁ at most equal to 75°. The reinforcers of the second carcass layer 62 form, with the circumferential direction XX′, an angle A₂ at least equal to 80° and at most equal to 90°. The difference between the angles (A1, A2) of the respective reinforcers of the first and second carcass layers (61, 62) is at least equal to 10° and at most equal to 20°. The angles (A1, A2) of the respective reinforcers of the first and second carcass layers (61, 62) are oriented in the same direction. The crown layer 51 comprises mutually parallel reinforcers forming, with the circumferential direction XX′, an angle B at most equal to 5°.

The invention has been studied more particularly in the 200/55 ZR 17 size. In this particular case, the angle A1 of the reinforcers of the radially inside turned-up first carcass layer is equal to 75°, the angle A2 of the reinforcers of the radially outside second carcass layer that has no turnup is equal to 90° and the angle B of the reinforcers of the single crown layer is equal to 0°. This architecture was compared against that of a tire of the state of the art comprising a radially inside turned-up first carcass layer of which the reinforcers form an angle A1 equal to −80°, a radially outside second carcass layer without a turnup, the reinforcers of which form an angle A2 equal to +80°, which are therefore criss-crossed with those of the first carcass layer, and a crown layer the reinforcers of which are circumferential.

In this study, the reinforcers of the two carcass layers are made of polyester whereas the reinforcers of the crown layer are made of aramid. In addition, the mean radial distance respectively between the respective reinforcers of two consecutive carcass layers, in their crown portions, on the one hand, and between the respective reinforcers of the radially outermost carcass layer, in its crown portion, and of the crown layer, on the other hand, is equal to 0.1 mm for the tire according to the invention and to 0.3 mm for the reference tire of the prior art.

The two tires were tested on a motorbike in subjective tests of stability in a straight line and in a curve. The results obtained are given in table 1 below:

TABLE 1

| | Reference | Invention |
|---|---|---|
| Stability in a straight line | 100 | 120 |
| Stability in a curve | 100 | 140 |

The invention should not be interpreted as being limited to the description of the examples above and notably extends to tires that may comprise carcass reinforcements comprising more than two carcass layers and a crown reinforcement comprising more than one crown layer. Moreover, all the combinations of carcass layers with and/or without turnups are conceivable. Finally, the crown layer reinforcers are not limited to textile materials, but may be made of metal.

1. Tire for a motorized two-wheel vehicle of the motorbike type, comprising:
a tread connected by two sidewalls to two beads, each said bead comprising a metal circumferential reinforcing element or bead wire;
a crown reinforcement extending radially inside the tread and comprising at least one crown layer, the at least one crown layer comprising mutually parallel reinforcers forming, with a circumferential direction of the tire, an angle at most equal to 5°;
a carcass reinforcement extending radially on the inside of the crown reinforcement as far as into the beads and comprising at least two carcass layers, each of the at least two carcass layers comprising mutually parallel reinforcers forming, with the circumferential direction of the tire, an angle at least equal to 65°,
wherein the reinforcers of a first of said carcass layers forms, with the circumferential direction, an angle at most equal to 75°, wherein the reinforcers of a second of said second carcass layers forms, with the circumferential direction, an angle at least equal to 80° and at most equal to 90°, wherein the difference between the angles of the respective reinforcers of the first and second carcass layers is at least equal to 10° and at most equal to 20° and wherein the angles of the respective reinforcers of the first and second carcass layers are oriented in the same direction.

2. The tire according to claim 1, wherein the carcass reinforcement is made up of two carcass layers.

3. The tire according to claim 1, wherein the first carcass layer is a carcass layer turned up around the bead wire of each said bead.

4. The tire according to claim 1, wherein the first carcass layer is radially on the inside of the second carcass layer.

5. The tire according to claim 1, each said bead comprising a metallic circumferential reinforcing element or bead wire, wherein the second carcass layer is a carcass layer not turned up around the bead wire of each said bead.

6. The tire according to claim 1, wherein the respective reinforcers of the first and second carcass layers are made of textile material.

7. The tire according to claim 1, wherein the respective reinforcers of the first and second carcass layers are made of the same textile material.

8. The tire according to claim 1, wherein the respective reinforcers of the first and second carcass layers are made of polyester.

9. The tire according to claim 1, wherein the crown reinforcement is made of one single crown layer.

10. The tire according to claim 1, wherein the reinforcers of the at least one crown layer are made of textile material.

11. The tire according to claim 1, each of the at least two carcass layers having a crown portion extending symmetrically on each side of an equatorial plane passing through the middle of the tread and perpendicular to an axis of rotation of the tire, wherein the mean radial distance respectively between the respective reinforcers of two consecutive said carcass layers, in their crown portions, on the one hand, and between the respective reinforcers of the radially said outermost carcass layer, in its crown portion, and of the radially said innermost crown layer, on the other hand, is at most equal to 0.3 mm.

12. The tire according to claim 11, wherein the mean radial distance is at most equal to 0.1 mm.

13. The tire according to claim 10, wherein the textile material is aromatic polyamide.
